(19) United States
(12) Patent Application Publication
(10) Pub. No.: US 2011/0103814 A1
(43) Pub. Date: May 5, 2011

(54) IMAGE FORMING APPARATUS AND IMAGE FORMING METHOD

(75) Inventors: Hiroshi TOYAMA, Shiojiri (JP); Ken IKUMA, Suwa (JP)

(73) Assignee: SEIKO EPSON CORPORATION, Tokyo (JP)

(21) Appl. No.: 12/892,232

(22) Filed: Sep. 28, 2010

(30) Foreign Application Priority Data
Nov. 2, 2009 (JP) 2009-251907

(51) Int. Cl. G03G 15/00

(52) U.S. Cl. 399/49

(57) ABSTRACT

The image forming apparatus includes a first latent image carrier; a first developing member develops the latent image by a first liquid developer; a second latent image carrier; a second developing member develops the latent image by a second liquid developer; a transfer medium that forms first and second nip portion; a detecting unit; and a control unit, that, when the first image is a first image density, detect the first image passed through the second nip portion formed by the transfer medium and the second latent image carrier while the second developing member contacts with the second latent image carrier, and when the first image is a second image density higher than the first image density, detect the first image passed through the second nip portion formed by the transfer medium and the second latent image carrier while the second developing member separates form the second latent image carrier.

### BACKGROUND

1. Technical Field

The present invention relates to an image forming apparatus and an image forming method which can form an image by developing a latent image with a liquid developer containing a liquid carrier and toner, and detect the corresponding image.

2. Related Art

In the related art, an image forming apparatus of an electrophotographic type has been put to practical use, in which a latent image carrier, such as a photosensitive drum charged with electricity, is exposed to by an exposure unit to form an electrostatic latent image on the latent image carrier, the electrostatic latent image is developed by adhering toner to the latent image carrier with a developing unit to form a toner image, and then the toner image is transferred onto a transfer paper to obtain a desired image. As a developing method of the developing unit, a liquid developing method using a developing liquid with toner dispersed in a liquid carrier is known. The liquid developing method has some advantages in that since the particle size of the toner is small, about 0.1 to 2 μm, an image of high resolution can be obtained, and since the toner is liquid, a uniform image can be obtained from the high fluidity. Therefore, various image forming apparatuses of a liquid developing method have been proposed (e.g., JP-A-2009-15351).

However, the image density of the toner image formed by above-described way depends upon an electric field applied to the charged toner at a developing position. Since the electric field is influenced by variations in developing bias, exposure energy, charging bias or the like, and dimensional variations in a developing gap, these variations have an effect on the image density of the toner image, thereby causing the image quality to deteriorate. In addition, in the liquid developing method, the image density can vary due to a variation in a mixture ratio of the toner and the liquid carrier or a variation in the film thickness of the toner formed by a developing roller constituting the developing unit. For example, according to the patent disclosed in JP-A-2009-15351, a plurality of high-density images or low-density images are formed while a contrast potential is changed, and then the image density of each image is detected by a reflective-type optical sensor (patch sensor) to obtain image forming conditions. Among the images, a solid patch image is formed as the high-density image, and high-density image forming conditions, in which the amount of the toner to be attached to the latent image carrier with respect to increased contrast potential is almost saturated, is obtained based on the image density detected by the optical sensor. In addition, feedback-control of the toner mixture ratio or the revolution speed of an anilox roller has been proposed so as to make the density of the solid image constant. Moreover, as the low-density patch image, a fine-line image consisting of one group of 1-dot lines based on a 1 ON/10 OFF dot-line pattern or an image consisting of isolated dots is used.

However, even though the solid patch image is formed in the liquid developing method, an upper surface of the toner layer forming the patch image is covered by the liquid carrier, which will be described later, so that the whole surface of the patch image is in the state of a mirror surface. In this case, since the light emitted from the optical sensor is reflected by the surface of the patch image, there are cases when the density of the patch image cannot be accurately detected.

In addition, the detection of the image density of the low-density patch image in the liquid developing method plays an important role of detecting fog, as well as the technical significance of obtaining the image forming conditions. That is, in the liquid developing method, in order to prevent clumping together of the toner on the developing roller between a non-image area and paper, an image forming condition is used in which the non-image area is easily fogged by increasing the developing bias and the fog toner is collected by a squeeze roller to which squeeze bias is applied. In this case, there are cases when it is difficult to remove the fog by the squeeze roller because of variations in the mixture ratio of the toner and the carrier or in the film thickness of the toner. Accordingly, the fog is detected by detecting the image density of the low-density patch image, and the squeeze bias is feedback-controlled based on the detection result, so that the fog is effectively removed by the squeeze roller. However, since very fine toner particles are used in the liquid developing method, there is no large difference between the unevenness of the surface of the transfer medium, such as an intermediate transfer belt, onto which the patch image is transferred from the latent image carrier, and the unevenness due to the presence of the toner. Therefore, it is difficult to accurately detect the fog based on the low-density patch image transferred onto the transfer medium. In particular, in a case where the surface of the transfer medium is provided with an elastic layer so as to increase the adhesion between the transfer medium and the recording paper and thus improve the transfer property of the toner image onto the recording paper, the above-mentioned problem is more remarkable.

With the image forming apparatus of the liquid developing method, since the liquid developer is used, it is difficult to obtain the appropriate image forming condition, thereby causing the image quality to deteriorate.

### SUMMARY

An advantage of some aspects of the invention is that image density is accurately obtained in an image forming apparatus and an image forming method which forms an image by developing a latent image with a liquid developer containing a liquid carrier and toner.

According to one aspect of the invention, the image forming apparatus includes a first latent image carrier which carries a latent image; a first developing member which contacts with the first latent image carrier to develop the latent image carried on the first latent image carrier by a first liquid developer including a liquid carrier and toner; a second latent image carrier which carries a latent image; a second developing member which contacts with the second latent image carrier to develop the latent image carried on the second latent image carrier by a second liquid developer which is different from the first liquid developer; a transfer medium which contacts with the first latent image carrier to form a first transfer nip portion, onto which the image developed on the first latent image carrier is transferred at the first transfer nip portion, and contacts with the second latent image carrier to form a second transfer nip portion, onto which the image developed on the second latent image carrier is transferred at the second transfer nip portion; a detecting unit which detects the image transferred onto the transfer medium; and a control unit, which, when the image developed on the first latent image carrier is an image of a first image density, causes the detecting unit to detect the image of the first image density having passed through the second transfer nip portion which is formed by contacting of the transfer medium and the second latent image carrier contacting with the second developing member, and which, when the image developed on the first latent image carrier is an image of a second image density which is higher than the first image density, causes the second developing member to be separated from the second latent image carrier, and causes the detecting unit to detect the image of the second image density having passed through the second transfer nip portion which is formed by contacting of the transfer medium and the second latent image carrier separated from the second developing member.

In addition, according to another aspect of the invention, the image forming method includes the steps of: transferring an image of a first image density, which is developed on a first latent image carrier by a first developing member using a liquid developer containing a liquid carrier and toner, onto a transfer medium; passing the image of the first image density, which is transferred onto the transfer medium, through a second transfer nip portion formed by contacting of the transfer member and a second latent image carrier contacting with a second developing member; detecting the image of the first image density passing through the second transfer nip portion at a detecting unit; transferring an image of a second image density, which is higher than the first image density of the image developed on the first latent image carrier, onto the transfer medium; spacing the second developing member away from the second latent image carrier, and passing the image of the second image density through the second transfer nip portion formed by contacting of the transfer member and the second latent image carrier, which is separated from the second developing member; and detecting the image of the second image density passing through the second transfer nip portion at the detecting unit.

According to the invention (image forming apparatus and image forming method) having the configuration described above, two kinds of images transferred onto the transfer medium from the first latent image carrier at the first transfer nip portion, that is, (1) the image of the first image density and (2) the image of the second image density higher than the first image density, pass through the second transfer nip portion and then are detected by the detecting unit. The second transfer nip portion is formed by contacting of the transfer medium and the second latent image carrier. However, when the image of the first image density transferred onto the transfer medium passes through the second transfer nip portion, the second developing member contacts with the second latent image carrier. When the image of the second image density transferred onto transfer medium passes through the second transfer nip portion, the second developing member is moved to a position separated from the second latent image carrier. The position of the second developing member is switched depending upon the kinds of the images. The reason is as follows:

The image of the first image density is an image with lower density than that of the image of the second image density, for example, a fine-line image consisting of one group of 1-dot lines based on a 1 ON/10 OFF dot-line pattern or an image consisting of isolated dots. However, in the case where the surface of the transfer medium has the unevenness, it is difficult to distinguish it from an unevenness of the toner forming the low-density image. This is one of the reasons of deteriorating detection precision of the image of the first image density. In the invention, however, the second developing member contacts with the second latent image carrier, and then the image of the first image density passes through the second transfer nip portion through the second liquid carrier in the state in which the liquid developer (liquid carrier) can be exchanged between the second developing member and the second latent image carrier. Therefore, the surface of the transfer medium becomes uniform and the unevenness of the surface is reduced. As a result, it is possible to detect the image of the first image density with high precision by the detecting unit.

On the other hand, the image of the second image density is an image density higher than the image of the first image density, for example, a solid image. However, the upper surface of the toner layer forming the image of the second image density is covered by the liquid carrier, so that the whole surface of the image of the second image density is in the state of a mirror surface. In this case, it is difficult to accurately detect the density of the image of the second image density. In the invention, in the state in which the second developing member is separated from the second latent image carrier, the image of the second image density passes through the second transfer nip portion, and thus the liquid carrier existing on the surface layer portion of the image of the second image density is peeled off at the second transfer nip portion, so that the toner forming the image of the second image density is exposed. The image detection by the detecting unit is performed in the state in which the toner is exposed. Accordingly, it is possible to obtain the density of the image of the second image density formed on the transfer medium with high precision, based on the detection result of the detecting unit.

With the invention, the spacing and contacting of the second developing member with respect to the second latent image carrier is controlled depending upon the kinds of the images transferred onto the transfer medium, and after the surface of each image transferred onto the transfer medium is adjusted in a state suitable for the image detection, the image is detected by the detecting unit. Accordingly, it is possible to accurately obtain the density of the image of the first image density and the image of the second image density.

The image forming apparatus may further include a third latent image carrier which contacts with the transfer medium to form a third transfer nip portion and carries a latent image; and a third developing member which contacts with the third latent image carrier to develop the latent image carried on the third latent image carrier by a third liquid developer which is different from the first liquid developer and the second liquid developer; wherein when the image developed on the first latent image carrier is the image of the first image density, the control unit causes the detecting unit to detect the image of the first image density having passed through the third transfer nip portion which is formed by contacting of the transfer medium and the third latent image carrier contacting with the third developing member, and which, when the image developed on the first latent image carrier is the image of the second image density which is higher than the first image density, the control unit causes the third developing member to be separated from the third latent image carrier, and causes the detecting unit to detect the image of the second image density having passed through the third transfer nip portion which is formed by contacting of the transfer medium and the third latent image carrier separated from the third developing member.

According to the other aspect of the invention, an image forming apparatus includes a first latent image carrier which carries a latent image; a first developing member which contacts with the first latent image carrier to develop the latent image carried on the first latent image carrier by a first liquid developer including a liquid carrier and toner; a second latent image carrier which carries a latent image; a second developing member which contacts with the second latent image carrier to develop the latent image carried on the second latent image carrier by a second liquid developer which is different from the first liquid developer; a third latent image carrier which carries a latent image; and a third developing member which contacts with the third latent image carrier to develop the latent image carried on the third latent image carrier by a third liquid developer which is different from the first liquid developer and the second liquid developer; a transfer medium which contacts with the first latent image carrier to form a first transfer nip portion, onto which the image developed on the first latent image carrier is transferred at the first transfer nip portion, contacts with the second latent image carrier to form a second transfer nip portion, onto which the image developed on the second latent image carrier is transferred at the second transfer nip portion, and contacts with the third latent image carrier to form a third transfer nip portion, onto which the image developed on the third latent image carrier is transferred at the third transfer nip portion; a detecting unit which detects the image transferred onto the transfer medium; and a control unit, which, when the image developed on the second latent image carrier is an image of a first image density, causes the detecting unit to detect the image of the first image density having passed through the third transfer nip portion which is formed by contacting of the transfer medium and the third latent image carrier contacting with the third developing member, and which, when the image developed on the second latent image carrier is an image of a second image density which is higher than the first image density, causes the third developing member to be separated from the third latent image carrier, and causes the detecting unit to detect the image of the second image density having passed through the third transfer nip portion which is formed by contacting of the transfer medium and the third latent image carrier separated from the third developing member.

With the apparatus having the configuration described above, the first transfer nip portion, the second transfer nip portion, the third transfer nip portion and the detecting unit are arranged in the order along the moving direction of the transfer medium. The image transferred onto the transfer medium from the third latent image carrier at the second transfer nip portion passes through the third transfer nip portion, and then is detected by the detecting unit. The third transfer nip portion is formed by contacting of the transfer medium and the third latent image carrier. However, when the image of the first image density transferred onto the transfer medium passes through the third transfer nip portion, the third developing member is moved to the position in which it contacts with the third latent image carrier. For this reason, in the state in which the liquid developer (liquid carrier) can be exchanged between the third developing member and the third latent image carrier, the image of the first image density passes through the third transfer nip portion. Therefore, the surface of the transfer medium becomes uniform and the unevenness of the surface is reduced. On the other hand, when the image of the second image density passes through the third transfer nip portion, the third development member is moved to the position separated from the third latent image carrier. For this reason, a new liquid carrier is not supplied to the third latent image carrier from the third developing member. As a result, the liquid carrier existing on the surface layer portion of the image formed on the transfer medium is peeled off at the third transfer nip portion, and the toner configuring the image is exposed. Therefore, in the state in which the toner is exposed, the image detection is performed by the detecting unit. It is possible to obtain the density of the image formed on the transfer medium with high precision, based on the detection result of the detecting unit.

In addition, the image forming apparatus may further include a fourth latent image carrier which contacts with the transfer medium to form a fourth transfer nip portion and carries a latent image; and a fourth developing member which contacts with the fourth latent image carrier to develop the latent image carried on the fourth latent image carrier by a fourth liquid developer which is different from the first liquid developer, the second liquid developer and the third liquid developer; wherein when the image developed on the second latent image carrier is an image of the first image density, the control unit causes the detecting unit to detect the image of the first image density having passed through the fourth transfer nip portion which is formed by contacting of the transfer medium and the fourth latent image carrier contacting with the fourth developing member, and when the image developed on the second latent image carrier is an image of the second image density which is higher than the first image density, the control unit causes the fourth developing member to be separated from the fourth latent image carrier, and causes the detecting unit to detect the image of the second image density having passed through the fourth transfer nip portion which is formed by contacting of the transfer medium and the fourth latent image carrier separated from the fourth developing member.

Moreover, the image forming apparatus may further include a transfer roller with a concaved portion formed in a circumferential surface, in which when the concaved portion is not opposite to the transfer medium, the transfer roller contacts with the transfer medium to form a nip portion, with a recording medium being interposed between the transfer roller and the transfer medium, and the image transferred onto the transfer medium is transferred onto the recording medium at the nip portion. When the detecting unit detects the image, the control unit controls so that the concaved portion is opposite to the transfer medium to stop rotation of the transfer roller.

### BRIEF DESCRIPTION OF THE DRAWINGS

The invention will be described with reference to the accompanying drawings, wherein like numbers reference like elements.

FIG. 1 is a view illustrating an image forming apparatus according to a first embodiment of the invention.

FIG. 2 is a block diagram illustrating an electric configuration of the apparatus in FIG. 1.

FIG. 3 is a timing chart illustrating formation of a yellow patch image and operation of density detection in the image forming apparatus in FIG. 1.

FIGS. 4A to 4C are diagrams illustrating operation of the image forming apparatus in FIG. 1.

FIGS. 5A to 5C are timing charts illustrating formation of a black patch image and operation of density detection in the image forming apparatus in FIG. 1.

FIG. 6 is a view illustrating an image forming apparatus according to a second embodiment of the invention.

FIG. 7 is a block diagram illustrating an electric configuration of the apparatus in FIG. 6.

FIGS. 8A and 8B are views illustrating a configuration of a secondary transfer unit.

FIGS. 9A and 9B are views illustrating operation of a stopper member according to a second embodiment.

FIG. 10 is a timing chart illustrating formation of a magenta patch image and operation of density detection in the image forming apparatus in FIG. 6.

### DESCRIPTION OF EXEMPLARY EMBODIMENTS

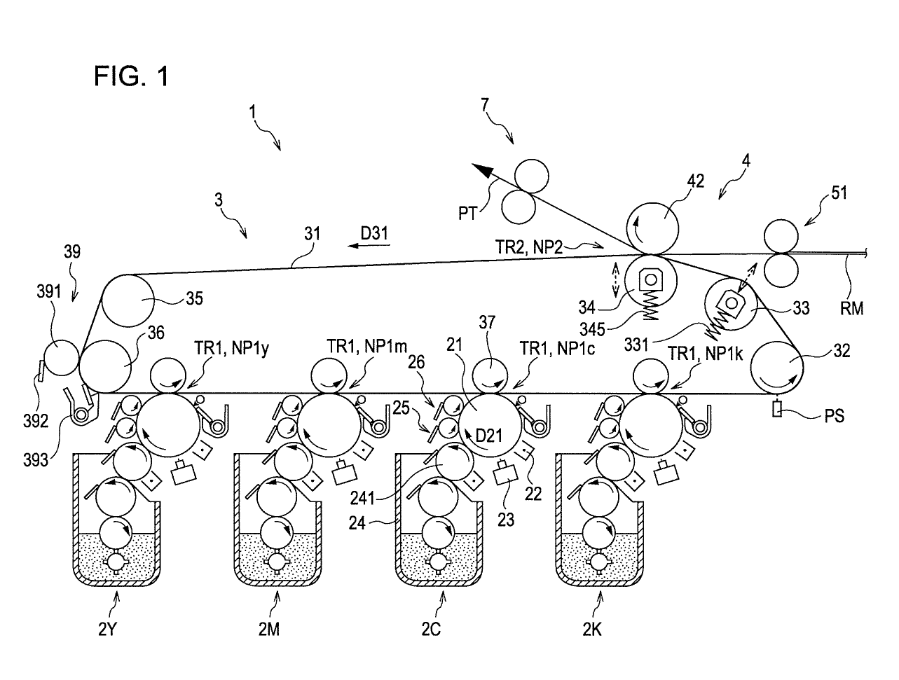

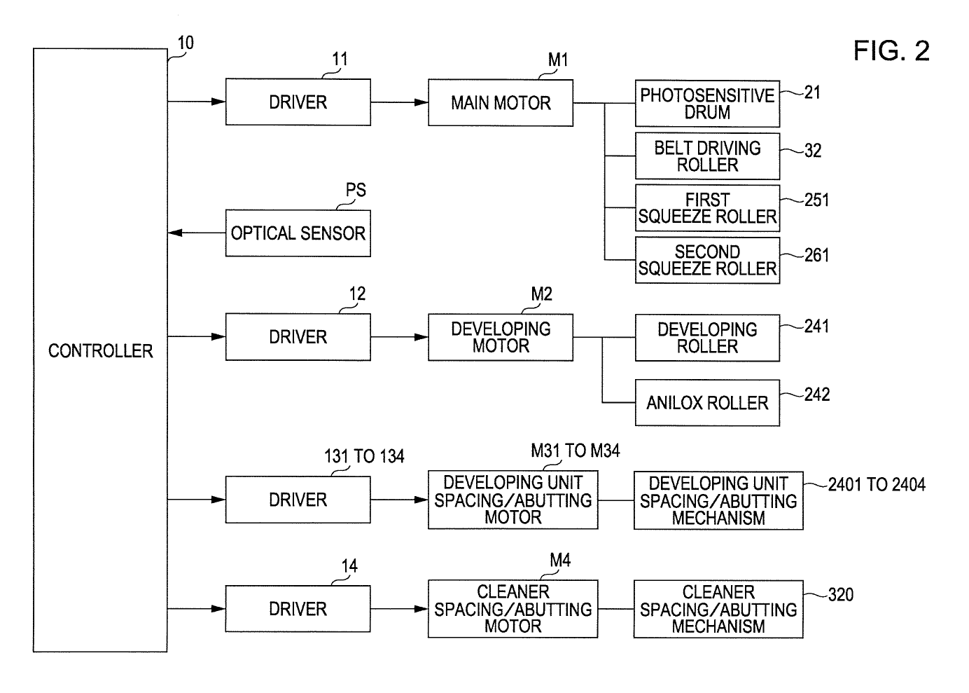

FIG. 1 is a view illustrating an image forming apparatus according to a first embodiment of the invention. FIG. 2 is a block diagram illustrating an electric configuration of the apparatus in FIG. 1. An image forming apparatus 1 includes four image forming stations 2Y (for yellow), 2M (for magenta), 2C (for cyan), and 2K (for black) for forming images of different colors. The image forming apparatus 1 can selectively execute a color mode in which toner of four colors, yellow (Y), magenta (M), cyan (C) and black (K), are superposed to form a color image, and a monochromatic mode in which only black (K) toner is used to form an monochromatic image. In this image forming apparatus, when an image forming instruction signal is fed to a controller 10 having a CPU or a memory from an external apparatus such as a host computer, the controller 10 controls respective sections of the apparatus to execute a desired operation of image formation and thereby forms images corresponding to the image forming instruction signal on a recording medium RM of a sheet type, such as copy paper, transfer paper, paper, or transparent OHP sheets.

Each of the image forming stations 2Y, 2M, 2C and 2K has the same structure and function, except for toner color. Accordingly, in FIG. 1, only each component constituting the image forming station 2C are denoted by reference numerals in order to easily see the accompanying drawings, and reference numerals to be denoted to other image forming stations 2Y, 2M and 2K will be omitted. In addition, although the structure and operation of the image forming station 2C will be described with reference to reference numerals denoted in FIG. 1, the structure and operation of the other image forming stations 2Y, 2M and 2K are the same as each other except for having different toner color.

The image forming station 2C is provided with a photosensitive drum 21, in which a toner image of cyan color is formed on the surface thereof. The photosensitive drum 21 is disposed in such a way that a rotational shaft thereof is parallel or almost parallel to a main scan direction (a direction perpendicular to a paper surface of FIG. 1), and is rotatably driven at the predetermined velocity in the arrow direction D21 shown in FIG. 1.

Around the photosensitive drum 21, a charging unit 22, which is a corona charging unit, for charging the surface of the photosensitive drum 21 at a predetermined electric potential, an exposure unit 23 for exposing the surface of the photosensitive drum 21 to light in accordance with the image signal to form an electrostatic latent image, a developing unit 24 for developing the electrostatic latent image as a toner image, a first squeeze portion 25, a second squeeze portion 26, and a cleaning unit for cleaning the surface of the photosensitive drum 21 after the transfer are arranged in this order along the rotational direction D21 (clockwise rotation in FIG. 1) of the photosensitive drum 21.

The charging unit 22 is not in contact with the surface of the photosensitive drum 21, and a corona charging unit which is well known in the related art may be used as the charging unit 22. In a case where a scorotron charging unit is used as the corona charging unit, a wire current flows in a charging wire of the scorotron charging unit, and DC grid charge bias is applied to a grid. The photosensitive drum 21 is charged by corona discharge caused by application of the charge bias to the charging unit 22 from a charge bias generating unit which is not illustrated, so that the surface of the photosensitive drum 21 is set to an approximately uniform electric potential.

The exposure unit 23 exposes the surface of the photosensitive drum 21 with the light beam in accordance with the image signal which is fed from an external device, so as to form an electrostatic latent image which corresponds to an image signal. The exposure unit 23 may be configured to emit the light beam from a semiconductor laser via a polygon mirror, or may include a line head with light emitting elements arranged in the main scan direction or the like.

The electrostatic latent image formed by such a process is applied with toner from the developing unit 24, so that the electrostatic latent image is developed by the toner. The developing unit 24 of the image forming apparatus 1 includes a developing roller 241. The developing roller 241 is a member of a cylindrical shape, of which an outer circumference of an inner core made of metal such as iron is provided with an elastic layer such as polyurethane rubber, silicon rubber, NBR, PFA tube or the like. The developing roller 241 is connected to a developing motor M2, and is rotatably driven in a counterclockwise direction on the paper of FIG. 1 to be with-rotated with respect to the photosensitive drum 21. In addition, the developing roller 241 is electrically connected to a developing bias generating source which is not illustrated, and is configured to be applied with a developing bias at an appropriate timing.

In addition, the developing unit 24 is provided with an anilox roller for supplying a liquid developer to the developing roller 241, and the liquid developer is supplied to the developing roller 241 from a developer storage unit through the anilox roller. The anilox roller has a function of supplying the liquid developer to the developing roller 241. The anilox roller is a roller having concaved patterns formed with grooves engraved in fine and uniform spiral shapes or the like on the surface so as to easily carry liquid developer. Similar to the developing roller 241, a metal core wound with a rubber layer such as urethane or NBR, or the one covered by a PFA tube is used as the anilox roller. In addition, the anilox roller is connected to the developing motor M2 and then is rotated.

The liquid developer that is stored in a developer storage unit is not a commonly used volatile liquid developer with low density (1 to 2 wt %) and low viscosity using Isopar (trademark: manufactured by Exxon Corp.) as a carrier and having volatility at a normal temperature, but is a liquid developer of high density and high viscosity (about 30 to 10000 mPa·S), in which a solid material with 1 μm of average grain diameter having a coloring agent such as pigment dispersed in non-volatile resin at a normal temperature is added along with a dispersant to liquid solvent such as organic solvent, silicon oil, mineral oil, or cooking oil and toner solid content density is about 20%.

By the above description, the developing roller 241 supplied with the liquid developer is rotated synchronously with the anilox roller, and is rotated in the same direction as the surface of the photosensitive drum 21. In this case, in order to form the toner image, the rotational direction of the surface of the developing roller 241 is necessary to be with-rotated so as to rotate in the same direction as the surface of the photosensitive drum 21, but it may be configured to rotate in any one of directions which are counter to or identical to the anilox roller.

The developing unit 24 having the configuration described above is connected to a developing unit separating/contacting mechanism 2403. As a rotational driving force is transmitted to the developing unit separating/contacting mechanism 2403 from a developing unit separating/contacting motor M33, the developing unit 24 can reciprocate between a developing position to develop the latent image on the photosensitive drum 21, and a retraction position separated from the photosensitive drum 21. Accordingly, during the time when the developing unit 24 is moved to and positioned at the retraction position, during this time, new supply of the liquid developer to the photosensitive drum 21 is stopped in the cyan image forming station 2C. Such a configuration is applied to case other image forming stations 2Y, 2M and 2K identically. That is, in the yellow image forming station 2Y, as the rotational driving force is transmitted to the developing unit separating/contacting mechanism 2401 from the developing unit separating/contacting motor M31, the developing unit 24 can reciprocate between the developing position and the retraction position. In the magenta image forming station 2M, as the rotational driving force is transmitted to the developing unit separating/contacting mechanism 2402 from the developing unit separating/contacting motor M32, the developing unit 24 can reciprocate between the developing position and the retraction position. In addition, in the black image forming station 2K, as the rotational driving force is transmitted to the developing unit separating/contacting mechanism 2404 from the developing unit separating/contacting motor M34, the developing unit 24 can reciprocate between the developing position and the retraction position.

A first squeeze portion 25 is provided at the downstream side of the developing position in the rotational direction D21 of the photosensitive drum 21, and a second squeeze portion 26 is provided further at the downstream side of the first squeeze portion 25. The squeeze portions 25 and 26 are provided with squeeze rollers 251 and 261, respectively. The squeeze roller 251 contacts with the surface of the photosensitive drum 21 at a first squeeze position and rotates by receiving the rotational driving force from the main motor M1, thereby removing surplus developer of the toner image. In addition, in the rotational direction D21 of the photosensitive drum 21, the squeeze roller 261 contacts the surface of the photosensitive drum 21 at a second squeeze position which is at the downstream side of the first squeeze position, and receives the rotational driving force from the main motor M1 to be rotated, thereby removing surplus liquid carrier of the toner image, or fog toner. Moreover, in order to improve the squeeze efficiency in this embodiment, a squeeze bias generating unit (not illustrated) is electrically connected to the squeeze rollers 251 and 261, so that squeeze bias is applied to the squeeze rollers at an appropriate timing. In this embodiment, two squeeze portions 25 and 26 are provided, but the number or placement of squeeze portions is not limited thereto. For example, one squeeze portion may be provided.

The toner image passing through the squeeze positions is primarily transferred onto an intermediate transfer member 31 of the transfer unit 3. The intermediate transfer member 31 is an endless belt serving as an image carrier capable of temporarily carrying the toner image on its surface, more specifically, on its outer circumference, and is suspended between a plurality of rollers 32, 33, 34, 35 and 36. The roller 32 is connected to the main motor M1 to function as a belt driving roller to drive the intermediate transfer member 31 in an arrow direction D31 in FIG. 1. In order to improve an adhesion property of the recording paper RM and enhance a property of transferring the toner image onto the recording paper RM in this embodiment, the surface of the intermediate transfer member 31 is provided with an elastic layer, and the surface of the elastic layer is configured to carry the toner image.

Although described in detail later, among the rollers 32 to 35 suspending the intermediate transfer member 31, only the belt driving roller 32 is driven by the main motor M1, and the other rollers 33 to 36 are follower rollers having no driving source. In addition, the belt driving roller 32 winds and suspends the intermediate transfer member 31 at the downstream side of the primary transfer position TR1 in the belt moving direction D31 and at the upstream side of a secondary transfer position TR2 which will be described later.

The transfer unit 3 includes a primary transferring backup roller 37. The primary transferring backup roller 37 is set up opposite to the photosensitive drum 21 so that the intermediate transfer member 31 is interposed between the photosensitive drum 21 and the primary transferring backup roller 37. At the primary transfer position TR1 in which the photosensitive drum 21 contacts with the intermediate transfer member 31, the outer circumference surface of the photosensitive drum 21 contacts with the intermediate transfer member 31 to form a primary transfer nip portion NP1c. Then, the toner image on the photosensitive drum 21 is transferred onto the outer circumference (bottom surface in the primary transfer position TR1) of the intermediate transfer member 31. Thus, the toner image of cyan color formed by the image forming station 2C is transferred onto the intermediate transfer member 31. Similarly, as the transfer of the toner images is performed in other image forming stations 2Y, 2M and 2K, the toner image of each color is sequentially overlapped on the intermediate transfer member 31, thereby a full color toner image is formed. On the other hand, when a monochrome toner image is formed, the transfer of the toner image to the intermediate transfer member 31 is performed only in the image forming station 2K corresponding to the black color. In addition, as described later, a solid patch image formed in the respective image forming stations 2Y, 2M, 2C and 2K is primarily transferred onto the intermediate transfer member 31 at the primary transfer nip portion. In this case, the image forming stations 2Y, 2M, 2C and 2K are provided in this order along the moving direction D31 of the intermediate transfer member 31, as shown in FIG. 1. Among the primary transfer nip portions formed by contacting of the respective photosensitive drums 21 against the intermediate transfer member 31, the primary transfer nip portion NP1y is positioned at the farthest upstream side in the moving direction D31, and the primary transfer nip portions NP1m, NP1c and NP1k are positioned in this order at the downstream side. The yellow toner image, the magenta toner image, the cyan toner image and the black toner image are respectively transferred onto the intermediate transfer member 31 in the primary transfer nip portions NP1y, NP1m, NP1c and NP1k.

The toner image transferred onto the intermediate transfer member 31 is transported to the secondary transfer position TR2 via a winding position of the belt driving roller 32. In the secondary transfer position TR2, a secondary transfer roller 42 is provided opposite to a roller 34 winding the intermediate transfer member 31, with the intermediate transfer member 31 being interposed between the secondary transfer roller 42 and the roller 34. The surface of the intermediate transfer member 31 contacts with the surface of the secondary transfer roller 42 to form a secondary transfer nip portion NP2. That is, the roller 34 functions as a secondary transferring backup roller. A rotational shaft of the backup roller 34 is elastically supported by a pressing member 345 which is an elastic member such as a spring, and is able to move close to or away from the intermediate transfer member 31.

In the secondary transfer position TR2, the monochrome toner image or the toner image of polychrome formed on the intermediate transfer member 31 is transferred onto the recording medium RM which is transported from a pair of gate rollers 51 along a transport passage PT. In addition, the recording medium RM secondarily transferred with the toner image is transmitted to a fixing unit 7, which is installed over the transport passage PT, from the secondary transfer roller 42. In the fixing unit 7, heat, pressure or the like is applied to the toner image transferred onto the recording medium RM to perform the fixing of the toner image on the recording medium RM.

Among the rollers suspending the intermediate transfer member 31, the follower roller 33 which is installed between the belt driving roller 32 and the secondary transferring backup roller 34, that is, at the downstream side from the winding position of the belt driving roller 32 in the belt moving direction D31 and at the upstream side from the winding position of the secondary transferring backup roller 34 is a tension roller, in which a rotational shaft thereof is elastically supported by a spring 331 to adjust tension of the intermediate transfer member 31. More specifically, the rotational shaft of the tension roller 33 is elastically supported by the spring 331 which is extendible in a direction approximately perpendicular to an imaginary plane which is adjacent to both the outer circumference of the driving roller 32 and the outer circumference of the secondary transferring backup roller 34. Therefore, the tension roller 33 is movable in the same direction by a predetermined amount in the state in which the intermediate transfer member 31 is wound on the tension roller. In the normal state, in order to press and extend the intermediate transfer member 31, which is suspended between the belt driving roller 32 and the secondary transferring backup roller 34, towards the outside, the tension roller 33 is pressed by the spring 331.

The tension roller 33 contacts with the intermediate transfer member 31 from the inside of the intermediate transfer member 31, that is, from the surface opposite to the image carrying surface of the intermediate transfer member 31. The reason is as follows. First, as the tension roller 33 contacts with the opposite side of the image carrying surface, the tension roller 33 does not scatter the toner image carried on the intermediate transfer member 31, or is not contaminated by the toner or the like which remains and is adhered to the intermediate transfer member 31. In addition, it is effective to take a large winding angle of the intermediate transfer member 31 for increasing an effect of adjusting the tension of the tension roller. However, if the tension roller contacts with the image carrying surface and the winding angle is increased, it is necessary to provide the surface of the intermediate transfer member 31 with a large negative curvature, so that there are concerns about influence on the toner image and there may also be problems with its structure. For these reasons, the tension roller 33 contacts with the rear surface of the intermediate transfer member 31.

An intermediate transfer member cleaning unit 39 is installed opposite to the roller 36 out of the rollers 35 and 36 which are installed at the downstream side of the secondary transfer position TR2 in the transport direction D31 of the intermediate transfer member 31. More specifically, the intermediate transfer member cleaning unit 39 includes a cleaning roller 391 which contacts with the surface of the intermediate transfer member 31 wound around the roller 36 to remove the remaining liquid carrier or the attached substances, such as toner, and a blade 392 for scratching off attached substance on the cleaning roller 391. In addition, a belt cleaning blade 393 is installed at the downstream position of the cleaning roller 391. The belt cleaning blade is configured to be able to be separated from and contact with the intermediate transfer member 31, and finally eliminates the remaining substances which are not completely eliminated by the cleaning roller 391. In this case, the intermediate transfer member cleaning unit 39 is connected to a cleaner separating/contacting mechanism 320, and as a rotational driving force is transmitted to the cleaner separating/contacting mechanism 320 from a cleaner separating/contacting motor M4, the cleaning roller 391 and the belt cleaning blade 393 of the intermediate transfer member cleaning unit 39 can be integrally separated from and contact with the surface of the intermediate transfer member 31.

In this embodiment, the photosensitive drum 21 having a diameter of 78 mm is used, and the intermediate transfer member 31 employs an intermediate transfer belt having a circumferential length of 1890 mm. In addition, drivers 11, 12, 131 to 134, and 14 are installed to control the drive of the motors M1, M2, M31 to M34, and M4 in accordance with operation commands from the controller 10. In particular, as the main motor M1 is driven by the driver 11, the photosensitive drum 21, the intermediate transfer member 31 and the squeeze rollers 251 and 261 are driven to rotate so that the process velocity becomes 250 (mm/sec).

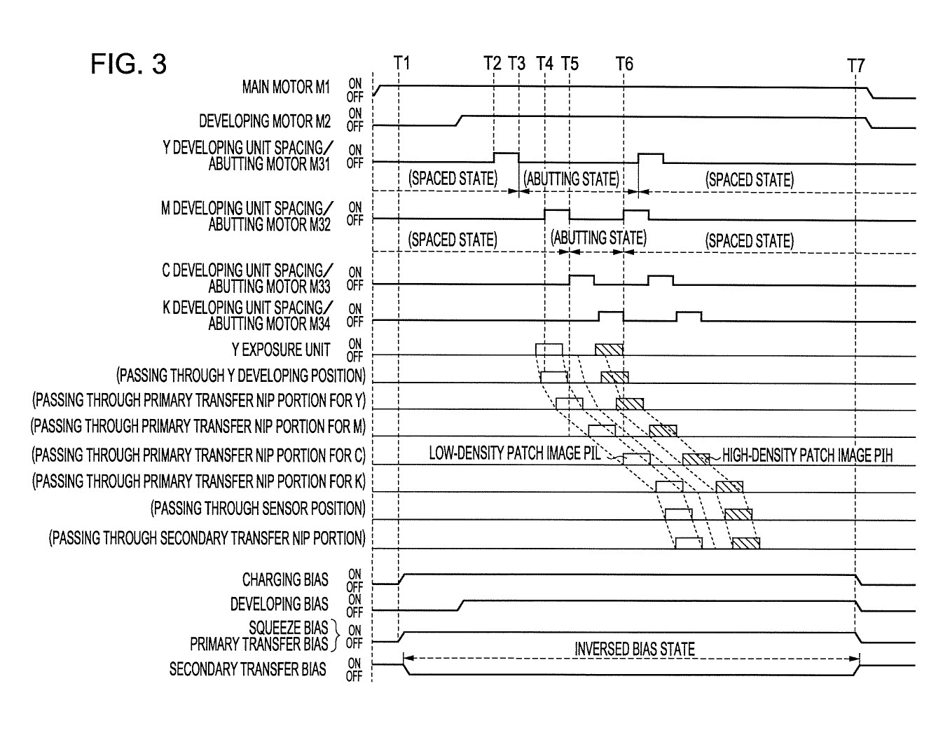

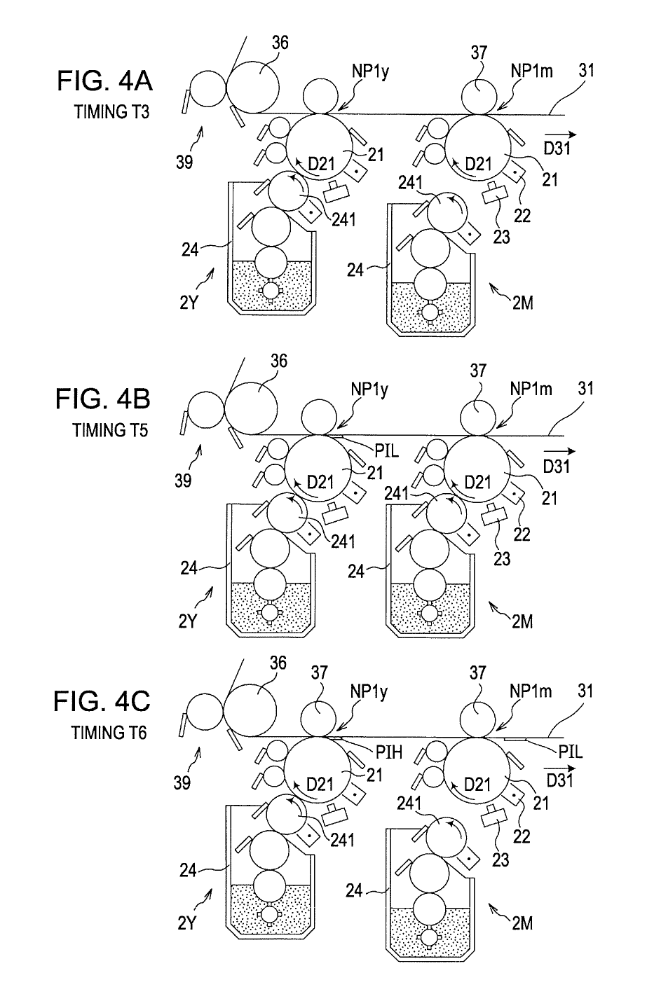

In the image forming apparatus 1 having the configuration described above, it is preferable to form the image under appropriate image forming conditions, similar to the image forming apparatus disclosed in JP-A-2009-15351. Accordingly, similar to the image forming apparatus, a fine-line image consisting of one group of 1-dot lines based on a 1 ON/10 OFF dot-line pattern or 1 ON/20 OFF dot-line pattern is formed as the low-density patch image, and the image density of the low-density patch image is detected by an optical sensor PS, so that the image forming condition is obtained to form an appropriate low-density image based on the detected result (low-density patch process). In addition, the fogging amount is obtained by the controller 10 based on the detected result to feedback control the squeeze bias. Moreover, a solid patch image is formed as a high-density patch image, and the image density of the solid patch image is detected by the optical sensor PS. The image forming conditions to form an appropriate high-density image is obtained by controller 10 based on the detected result (solid patch process). The optical sensor PS is installed between the primary transfer nip portion NP1k and the secondary transfer nip portion NP2 in the moving direction D31 of the intermediate transfer member 31, and particularly is installed to be opposite to the winding portion of the intermediate transfer member 31 around the belt driving roller 32 in the first embodiment. The formation of the low-density patch image and the solid patch image for the yellow color which is the first color, and the operation of density detection for both patch images will now be described in detail with reference to FIGS. 3 and 4.

FIG. 3 is a timing chart illustrating the formation of the yellow patch image and the operation of density detection in the image forming apparatus in FIG. 1. FIG. 4 is a diagram illustrating the operation of the image forming apparatus in FIG. 1. In the image forming apparatus 1 according to the embodiment, the controller 10 controls the respective units of apparatus according to the program stored in a memory (not illustrated) of the controller 10 to perform the formation of the low-density patch image and the solid patch image for the yellow color (first color), and the operation of density detection for both patch images as follows. That is, when the main motor M1 starts to operate, the photosensitive drum 21, the intermediate transfer member 31, and the squeeze rollers 251 and 261 start to rotate for all of the colors, and the driving roller 32 rotates, so that the intermediate transfer member 31 starts to rotate in the moving direction D31 in a circulating manner. In this case, rotation of the developing motor M2 is stopped, and the developing roller 241 and the anilox roller for every color are in a state of being rotationally stationary with regard all of the colors. In this state, the developing unit 24 is provided at the retracting which is separated from the photosensitive drum 21. In addition, the cleaning roller 391 and the belt cleaning blade 393 of the intermediate transfer member cleaning unit 39 are positioned to contact with the surface of the intermediate transfer member 31.

At the timing T1 in which the rotation of the photosensitive drum 21 is in the normal state, application of charging bias to the charging unit 22, application of squeeze bias to the squeeze rollers 251 and 261, and application of primary transfer bias to the intermediate transfer member 31 are performed. In addition, at the same time or after that, reverse bias starts to be applied to the secondary transfer roller 42. As the reverse bias is applied to the secondary transfer roller 42, even though the patch image formed on the intermediate transfer member 31 passes through the secondary transfer nip portion NP2, as described later, it is possible to prevent the patch image from being transferred to the secondary transfer roller 42, thereby performing an idling operation while reliably preventing contamination of the secondary transfer roller 42. In this case, the application of the reverse bias is stopped after the patch image is cleaned and removed at the belt cleaner position of the intermediate transfer member cleaning unit 39, which will be described later.

The developing motor M2 starts to rotate after a predetermined time has passed from the timing T1, and the developing roller 241 and the anilox roller rotate and are rotated while the developing bias is applied. Then, the yellow (first color) developing unit separating/contacting motor M31 is operated for a predetermined time (for 2 seconds in this embodiment) from the following timing T2, and the developing unit separating/contacting mechanism 2401 receives the rotational driving force to contiguously move the yellow developing unit 24 toward the photosensitive drum 21, so that the developing roller 241 contacts with the surface of the photosensitive drum 21 (contacting state). By the above operations, the developing preparation for the yellow color is completed at the timing T3 (FIG. 4A). In this case, at the timing T3, the developing unit 24 is separated from the photosensitive drum 21 in the second color (magenta) image forming station 2M, but (second color) the magenta developing unit separating/contacting motor M32 operates in accordance with the position of the low-density patch image and the solid patch image which are formed in the image forming station 2Y and are transferred onto the intermediate transfer member 31, so that the magenta developing unit 24 is controlled to be separated from and contact with the photosensitive drum 21. While not illustrated in FIG. 3, the third color (cyan) and the fourth color (black) are similar to the second color in this point.

In the image forming station 2Y, the image signal corresponding to the low-density patch image is transmitted to the exposure unit 23, so that the latent image corresponding to the low-density patch image is formed on the surface of the photosensitive drum 21. In this embodiment, the controller 10 is provided with a generator for the corresponding image signal, in which the generator outputs the image signal corresponding to the solid patch image which will be described later, but an aspect of supplying the image signal corresponding to the patch image is not limited thereto. This regard is similar to the following embodiment.

As the photosensitive drum 21 rotates, the latent image corresponding to the low-density patch image moves to the developing position, and the corresponding latent image is developed by the liquid developer (liquid carrier and toner) so that the low-density patch image PIL of the yellow color is formed on the surface of the photosensitive drum 21. The low-density patch image PIL is transported to the primary transfer nip portion NP1y, is primarily transferred onto the intermediate transfer member 31, and then is transported to the primary transfer nip portion NP1m. In this embodiment, before the low-density patch image PIL is transported to the primary transfer nip portion NP1m, the developing unit 24 is moved toward the photosensitive drum 21 in the image forming station 2M so that the developing roller 241 contacts with the circumferential surface of the photosensitive drum 21. More specifically, as shown in FIG. 3, at roughly the same time that the developing process is started by the yellow (first color) developing unit 24, the magenta (second color) developing unit separating/contacting motor M32 is operated only for a predetermined time (=T5−T4), and the developing unit separating/contacting mechanism 2402 receives the rotational driving force to move the magenta developing unit 24 toward the photosensitive drum 21, so that the developing roller 241 contacts with the surface of the photosensitive drum 21 (refer to FIG. 4B).

The low-density patch image PIL, which is primarily transferred at the primary transfer nip portion NP1y, is moved in the moving direction D31 of the intermediate transfer member 31, and passes through the primary transfer nip portion NP1m of the second color. In this case, since the magenta developing unit 24 contacts with the photosensitive drum 21, the intermediate transfer member 31 passes through the photosensitive drum 21 in the primary transfer nip portion NP1m of the image forming station 2M, and exchange of the liquid developer (liquid carrier) is performed between the developing unit 24 and the photosensitive drum 21, while the intermediate transfer member 31 passes through the primary transfer nip portion NP1m, the surface of the intermediate transfer member 31 becomes smooth to reduce the unevenness of the surface.

While the low-density patch image PIL passes through the primary transfer nip portion NP1m in the image forming station 2Y, an image signal corresponding to the solid patch image is applied to the exposure unit 23, so that the latent image corresponding to the solid patch image is formed on the surface of the photosensitive drum 21. If the latent image corresponding to the solid patch image moves to the developing position according to the rotation of the photosensitive drum 21, the latent image is developed by the liquid developer to form a solid patch image PIH of yellow color on the surface of the photosensitive drum 21, and then is further transported to the primary transfer nip portion NP1y to be primarily transferred onto the intermediate transfer member 31. In this embodiment, the operation of the yellow low-density patch image PIL passing through the primary transfer nip portion NP1m is performed with formation of the solid patch image PIH concurrently. At the timing T6 after the trailing end of the yellow low-density patch image PIL completely passes through the primary transfer nip portion NP1m, the magenta developing unit separating/contacting motor M32 is operated for a predetermined time, and the developing unit separating/contacting mechanism 2402 receives the rotational driving force from the motor to move the magenta developing unit 24 to the retraction position separated from the photosensitive drum 21, so that the developing roller 241 is separated from the surface of the photosensitive drum 21 (refer to FIG. 4C). In this embodiment, at the timing in which the low-density patch image PIL completely passes through the primary transfer nip portion NP1m and the solid patch image PIH does not reach the primary transfer nip portion NP1m, the magenta developing unit 24 is moved away from the photosensitive drum 21.

The solid patch image PIH primarily transferred in the primary transfer nip portion NP1y is transported in the moving direction D31 so as to chase the low-density patch image PIL, and passes through the second primary color transfer nip portion NP1m. However, before the solid patch image PIH reaches the primary transfer nip portion NP1m, the developing unit 24 is separated from the photosensitive drum 21. Since the solid patch image PIH passes through the primary transfer nip portion NP1m in this state, a surface layer portion of the liquid carrier is peeled off in the primary transfer nip portion NP1m during the passing.

In the image forming station 2M, the developing unit 24 is separated from and contacted with the photosensitive drum 21 in accordance with the timing in which the low-density patch image PIL and the solid patch image PIH pass through the primary transfer nip portion NP1m. The operation of spacing and contacting the developing unit 24 from and against the photosensitive drum 21 is identical to that in the third color image forming station 2C and, the fourth color image forming station 2K.

Accordingly, when the low-density patch image PIL transferred in the primary transfer nip portion NP1y passes through the primary transfer nip portions NP1m, NP1c and NP1k installed at the downstream side of the primary transfer nip portion NP1y in the moving direction D31, the surface of the intermediate transfer member 31 becomes uniform. Accordingly, after the unevenness of the surface is removed, the signal output from the optical sensor PS during the time PIL passes through the detection range of the optical sensor PS is input to the controller 10 to accurately obtain the image density of the low-density yellow patch image PIL. On the other hand, while the solid patch image PIH transferred at the primary transfer nip portion NP1y passes sequentially through the primary transfer nip portions NP1m, NP1c and NP1k, the surface layer portion of the liquid carrier is peeled off at the respective primary transfer nip portions NP1m, NP1c and NP1k. As a result, immediately after passing through the primary transfer nip portion NP1k which is provided at the farthest downstream side in the moving direction D31, the toner forming the solid patch image PIH is exposed on the surface of the patch image PIH. While the solid patch image PIH passes through the detection range of the optical sensor PS, the signal output from the optical sensor PS is output to the controller 10 to accurately obtain the image density of the yellow solid patch image PIH.

After detection of the low-density patch image PIL and the solid patch image PIH by the optical sensor PS is completed, the solid patch image PIH passes through the secondary transfer nip portion NP2, and moves to the belt cleaner position of the intermediate transfer member cleaning unit 39. The low-density patch image PIL and the solid patch image PIH moved to the belt cleaner position are cleaned and removed from the intermediate transfer member 31 by the intermediate transfer member cleaning unit 39. Then, at a timing T7 in which a predetermined time has passed since that time, the application of the charging bias, the developing bias, the squeeze bias, the primary transfer bias and the reverse bias is stopped. Subsequently, the rotation of the main motor M1 is stopped, the rotation of the photosensitive drum 21, the intermediate transfer member 31, and the squeeze rollers 251 and 261 is stopped. At the same time, the rotation of the developing motor M2 is stopped. In this way, the formation and the density detection of the yellow low-density patch image PIL and the solid patch image PIH are completed.

According to the first embodiment of the invention, the low-density patch image PIL and the solid patch image PIH are primarily transferred from the photosensitive drum 21 onto the intermediate transfer member 31 at the primary yellow transfer nip portion NP1y. However, the low-density patch image PIL and the solid patch image PIH pass through the primary transfer nip portions NP1m, NP1c and NP1k which are positioned at the downstream side of the primary transfer nip portion NP1y so that the surface is adjusted to a surface state suitable to detect the density. That is, the unevenness of the surface of the intermediate transfer member 31 with respect to the low-density patch image PIL becomes uniform, thereby reliably detecting the unevenness of the toner and thus properly obtaining the image forming conditions at the low-density side. In addition, since the fogging amount can be accurately obtained based on the density detection of the low-density patch image PIL, fog elimination can be properly performed at the second squeeze portion 26 by feedback controlling the squeeze bias on the basis of the detection result. In addition, when the solid patch image PIH passes through the respective primary transfer nip portions NP1m, NP1c and NP1k, the developing unit 24 is moved to a position separated away from the photosensitive drum 21. For this reason, a new liquid developer is not supplied to the photosensitive drum 21 from the developing unit 24 for any one of magenta, cyan and black. As a result, the liquid carrier existing on the surface layer portion of the solid patch image PIH which is formed on the intermediate transfer member 31 is peeled off by the respective primary transfer nip portions NP1m, NP1c and NP1k to expose the toner forming the solid patch image PIH, and the image detection by the optical sensor PS is performed in the exposed state. Therefore, it is possible to obtain the density of the solid patch image formed on the intermediate transfer member 31 with high precision on the basis of the detection result of the optical sensor PS. As a result, the image forming conditions at the high-density side can be properly obtained.

In this embodiment, the formation of the yellow low-density patch image PIL and the solid patch image PIH and the density detection of these patch images are performed, and the low-density patch image PIL corresponds to the “image of the first image density” of the invention. However, the low-density patch image may consist of an image formed of other 1-dot lines or isolated dots. In addition, the solid path image PIH corresponds to the “image of a second image density”. Moreover, the photosensitive drum 21 of the image forming station 2Y corresponds to the “first latent image carrier” of the invention, the primary transfer nip portion NP1y corresponds to the “primary transfer nip portion” of the invention, and the developing unit 24 corresponds to the “primary developing member” of the invention. In addition, the photosensitive drum 21 of the image forming station 2M corresponds to the “secondary latent image carrier”, the primary transfer nip portion NP1m corresponds to the “secondary transfer nip portion” of the invention, and the developing unit 24 corresponds to the “secondary developing member” of the invention. The photosensitive drum 21 of the image forming station 2C corresponds to the “third latent image carrier”, the primary transfer nip portion NP1c corresponds to the “third transfer nip portion” of the invention, and the developing unit 24 corresponds to the “third developing member” of the invention. In addition, the photosensitive drum 21 of the image forming station 2K corresponds to the “fourth latent image carrier”, the primary transfer nip portion NP1k corresponds to the “fourth transfer nip portion” of the invention, and the developing unit 24 corresponds to the “fourth developing member” of the invention.

In the case of performing the formation of the low-density patch image PIL and the solid patch image PIH for magenta and cyan and the density detection of these patch images, it is performed in the same way as that for yellow, so that the unevenness of the surface of the intermediate transfer member 31 becomes uniform with respect to the low-density patch image PIL to reliably detect a precise toner amount. In addition, it is possible to prevent the surface of the solid patch image PIH from being a mirror surface, thereby obtaining the density of the solid patch image PIH with high precision.

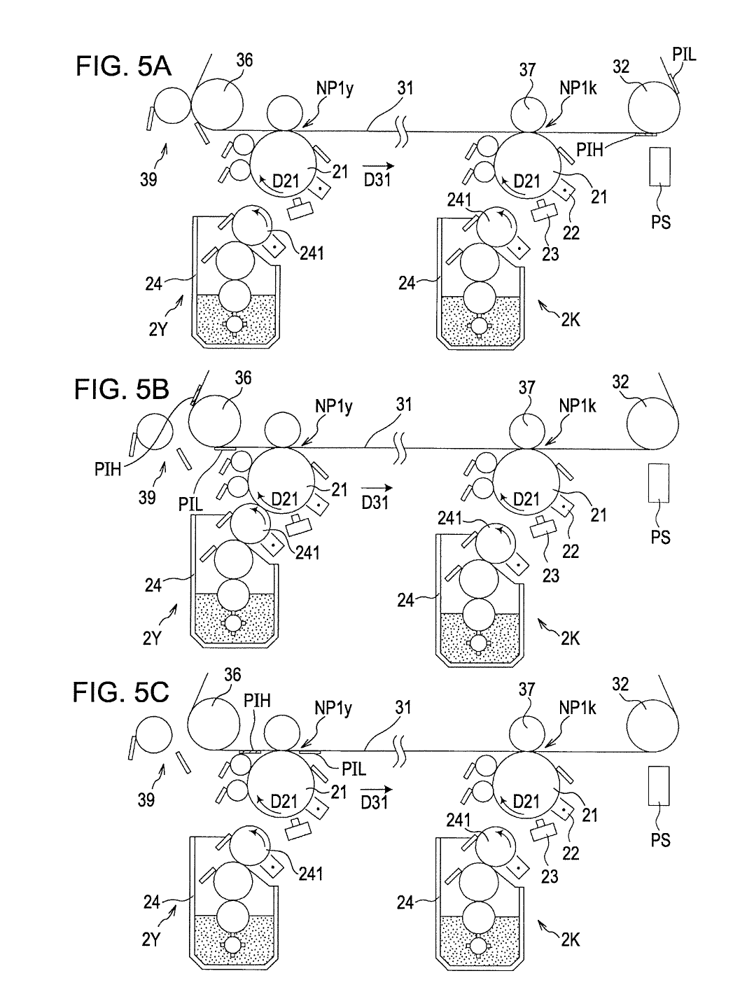

For black, as shown in FIG. 5, immediately after the low-density patch image PIL and the solid patch image PIH are formed on the intermediate transfer member 31, neither of the images PIL and PIH are detected by the optical sensor PS, but when each of the patch images PIL and PIH passes through the detection range of the optical sensor PS twice while the intermediate transfer member 31 idles, the controller 10 obtains the image density of the image PI based on the signal output from the optical sensor PS. That is, the low-density patch image PIL and the solid patch image PIH for black (fourth color) are formed at the image forming station 2K, which is the nearest one to the optical sensor PS, among four image forming stations, as shown in FIG. 5A, are transferred onto the intermediate transfer member 31 at the primary transfer nip portion NP1k, and then pass through the optical sensor PS. In addition, if the corresponding solid patch image PIH is separated from the primary transfer nip portion NP1k, the black developing unit separating/contacting motor M34 is operated for the predetermined time, and the developing unit separating/contacting mechanism 2404 receives the rotational driving force to move the black developing unit 24 to the retraction position which is separated from the photosensitive drum 21, so that the developing roller 241 is separated from the surface of the photosensitive drum 21. In this case, other developing units 24 are previously positioned at the retraction position separated from the photosensitive drum 21.

Until the low-density patch image PIL moves to the cleaning position, the cleaning roller 391 and the belt cleaning blade 393 are separated from the surface of the intermediate transfer member 31. The intermediate transfer member 31 idles for once rotation, so that the black low-density patch image PIL and the solid patch image PIH pass through the secondary transfer nip portion NP2 and the primary transfer nip portions NP1y, NP1m, NP1c and NP1k. The respective image forming stations move the developing unit 24 away from or toward the photosensitive drum 21 in accordance with the timing in which the low-density patch image PIL and the solid patch image PIH pass through the primary transfer nip portion. That is, when the low-density patch image PIL passes through the respective primary transfer nip portions NP1y, NP1m, NP1c and NP1k, as shown in FIG. 5B, the developing unit 24 contacts with the photosensitive drum 21. When passing through the primary transfer nip portions NP1y, NP1m, NP1c and NP1k, the surface of the intermediate transfer member 31 becomes uniform to remove the unevenness of the surface. While the patch images pass through the detection range of the optical sensor PS for the second time, the signal output from the optical sensor PS is sent to the controller 10 to accurately obtain the image density of the black low-density patch image PIL. When the solid patch image PIH passes through the respective primary transfer nip portions NP1y, NP1m, NP1c and NP1k, as shown in FIG. 5C, the developing unit 24 is separated from the photosensitive drum 21. In this way, the surface layer portion of the liquid carrier is peeled off at the primary transfer nip portions NP1y, NP1m, NP1c and NP1k, and the toner forming the solid patch image PIH is exposed to the surface of the patch image PIH. While the solid patch image PIH passes through the detection range of the optical sensor PS for the second time, the signal output from the optical sensor PS is sent to the controller 10 to accurately obtain the image density of the black solid patch image PIH.

In the case of forming the toner image in a wet developing mode in which the toner image is formed by using the liquid developer (liquid carrier and toner), pressing of the recording medium RM against the intermediate transfer member 31 with high pressure at the secondary transfer nip portion NP2 is required in order to obtain the good transfer characteristic. In addition, since the liquid developer is interposed therebetween, there is a high probability that the recording medium RM may adhere to the intermediate transfer member 31 and become jammed. Accordingly, the image forming apparatus 1 may utilize the secondary transfer roller 42 having a gripping unit, as described later.

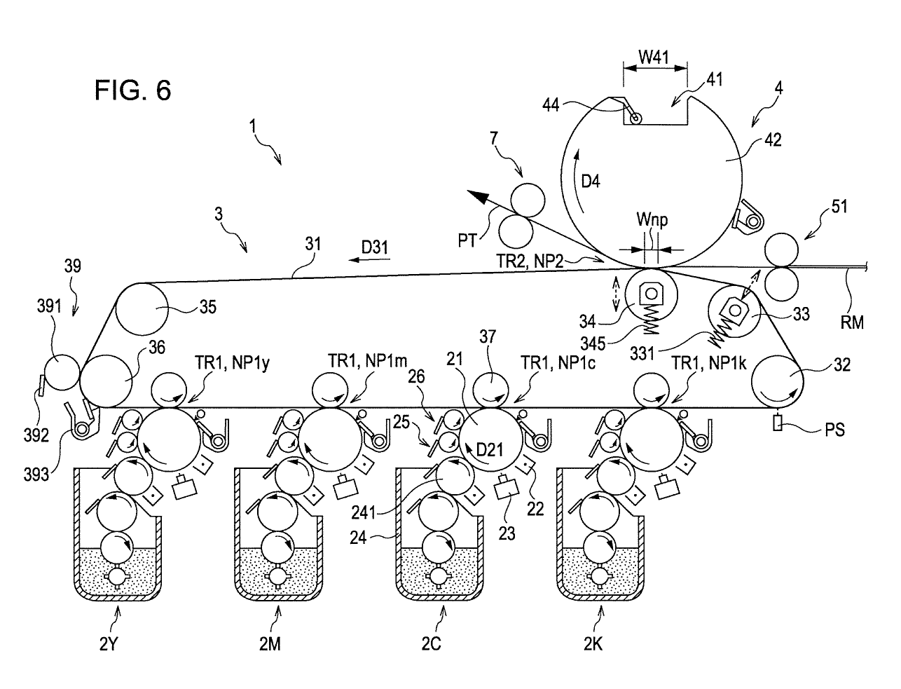

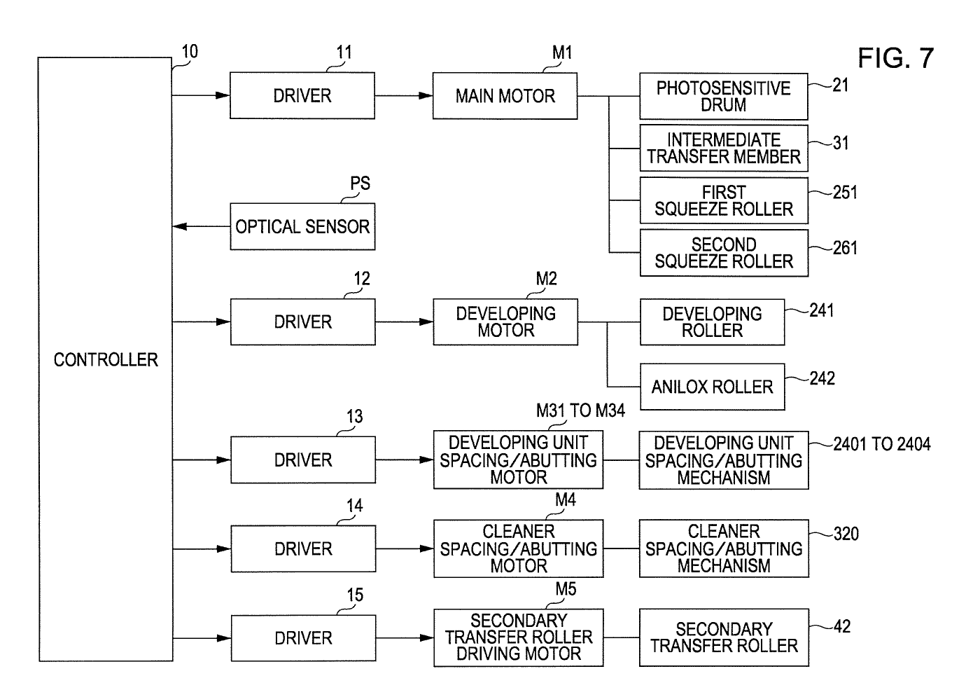

FIG. 6 is a view illustrating an image forming apparatus according to a second embodiment of the invention. FIG. 7 is a block diagram illustrating an electric configuration of the apparatus in FIG. 6. The second embodiment is similar to the first embodiment, except for the configuration of the secondary transfer unit 4, the formation of the patch images PIL and PIH and the operation of the density detection. Therefore, the differences will be mainly described later on the basis of the differences.

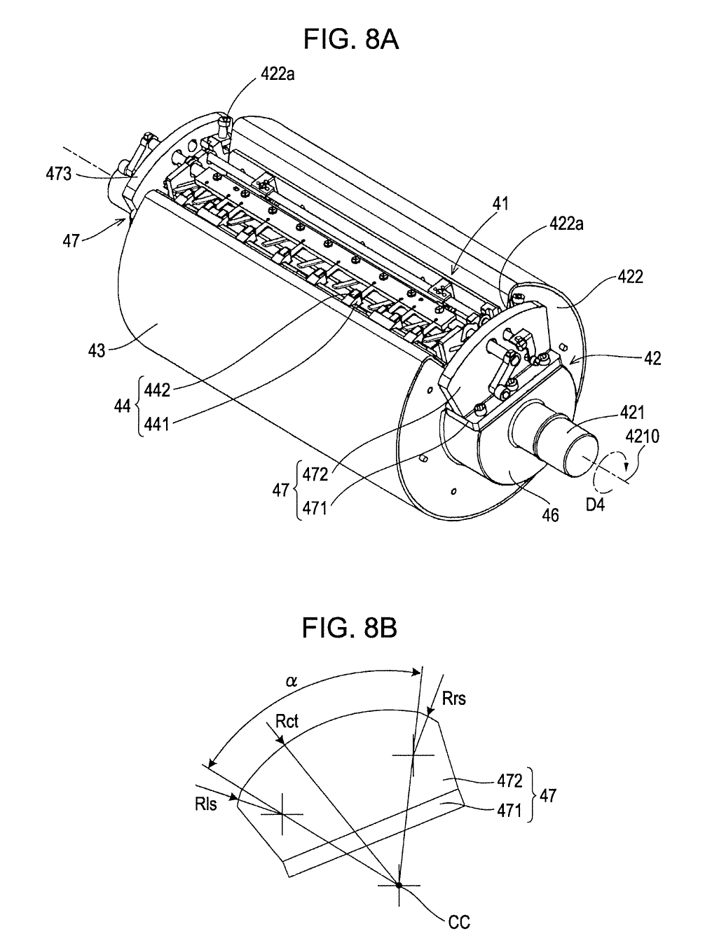

FIG. 8 is a view illustrating the configuration of the secondary transfer unit. More specifically, FIG. 8A is a perspective view illustrating the whole configuration of the secondary transfer unit 4, and FIG. 8B is a view for explaining the form of a stopper member 47. As shown in FIG. 6 and FIG. 8A, the secondary transfer unit 4 includes a secondary transfer roller 42 with a concaved portion 41 which is formed by cutting a portion of an outer circumference of a cylinder. The secondary transfer roller 42 is provided with a rotational shaft 421 which can be rotated around a rotational shaft 4210 in a direction D4 and is provided in parallel with or nearly parallel with the rotational shaft of the secondary transferring backup roller 34.

Lateral plates 422 and 422 are attached to both end portions of the rotational shaft 421. More specifically, the lateral plates 422 and 422 are made of a metal disc-type plate which is provided with a notch 422a. As shown in FIG. 8, the lateral plates are separated by a distance slightly longer than the width of the intermediate transfer member 31 and are attached to the rotational shaft 421, in the state in which the cut portions 422a and 422a are opposite to each other. In this way, the secondary transfer roller 42 has a drum shape in general, but a portion of the outer circumference of the secondary transfer roller is provided with the concaved portion 41 which extends in parallel with or nearly parallel with the rotational shaft 421.

In addition, an elastic layer 43 such as rubber or resin is formed on the outer circumference of the secondary transfer roller 42, that is the surface region, except for the inside of the concaved portion 41, among the surface of the metal plate. The elastic layer 43 is opposite to the intermediate transfer member 31 wound around the backup roller 34 to form the secondary transfer nip portion NP2. At the secondary transfer nip portion NP2, the backup roller 34 is pressed toward the secondary transfer unit 4 by the pressing member 345, so that a predetermined load (60 kgf in this embodiment) is applied between the secondary transfer unit 4 and the intermediate transfer member 31 wound around the backup roller 34.

Moreover, a gripping unit 44 is provided in the inside of the concaved portion 41 to grip the recording medium RM. The gripping unit 44 includes a gripper support member 441 installed on the outer circumference of the secondary transfer roller 42 from the inner bottom portion of the concaved portion 41, and a gripper member 442 supported to be able to be connected to or separated from the front end portion of the gripper support member 441. The gripper member 442 is connected to a gripper driving unit (not illustrated). As the gripper driving unit is operated in accordance with an ungrip command from the controller 10, the front end portion of the gripper member 442 is separated from the front end portion of the gripper support member 441 to perform the gripping preparation or gripping opening for the recording medium RM. On the other hand, as the gripper driving unit is operated in accordance with a grip command from the controller 10, the front end portion of the gripper member 442 moves toward the front end portion of the gripper support member 441 to grip the recording medium RM. In this case, the configuration of the gripping unit 44 is not limited to this embodiment, and other gripping mechanism known in the related art may be used.

At both end portions of the secondary transfer roller 42, a support member 46 is attached to the outer side of the respective lateral plates 422, and can be rotated integrally with the secondary transfer roller 42. In addition, the support member 46 is provided with a plane region 461 corresponding to the concaved portion 41. A transfer roller-side stopper member 470 is attached to the plane region 461. At the stopper member 470, a base portion 471 is attached to the support member 46, a stopper portion 472 extends in a normal direction of the plane region 461 from the base portion 471, and the front end portion of the stopper portion 472 extends to a position adjacent to an open lateral end portion of the concaved portion 41. That is, when viewing the secondary transfer roller 42 from the end portion of the rotational shaft 421, the stopper member 470 is provided to block the concaved portion 41. Accordingly, in the case where the concaved portion 41 comes to a position opposite to the intermediate transfer member 31 by the rotation of the secondary transfer roller 42, the stopper member 470 contacts with the surface of the end portion of the secondary transfer backup roller 34.

As shown in FIG. 8B, the circumferential surface of the front end portion of the stopper portion 472 is formed so that the curvature Rct of a central portion on the circumferential surface of the front end portion is larger than curvatures Rrs and Rls of both end portions. For example, in this embodiment, when the outer diameter of the secondary transfer roller 42 including the elastic layer 43 is set as about 191 mm, the curvature Rct is set as 88.2 mm, and curvatures Rrs and Rls of both end portions are set as 22.4 mm. The center of curvature CC of the central portion of the stopper member 47 is provided on the rotational shaft of the secondary transfer roller 42, that is, the central axis 4210 of the rotational shaft 421. In addition, the angular range α of the central portion is set as 63° which is slightly wider than the open range (60°) of the concaved portion 41. For this reason, when the secondary transfer roller 42 is rotated, the concaved portion 41 is opposite to the intermediate transfer member 31 wound around the driving roller 32 over the angle range α.

In addition, the length (opening width) W41 of the open portion of the concaved portion 41 along the rotational direction D4 of the secondary transfer roller 42 is:

191×π×(60/360)≈100 mm

In the angle range β (=360°−60°), the elastic layer 43 forms the nip NP opposite to the intermediate transfer member 31, which will be described later, and the length of the elastic layer 43 along the rotational direction D4 of the secondary transfer roller 42 is set as:

191×π×(300/360)≈500 mm

This is a setting to wind the largest one in size among the recording mediums RM which can be used in the apparatus 1 can be wound up. That is, the length of the elastic layer 43 is determined to be longer than the longest distance of one among the usable recording materials along the rotational direction D4 of the secondary transfer roller 42.

In this embodiment, the distance (nip width) Wnp of the nip NP along the rotational direction D4 of the secondary transfer roller 42 is about 11 mm, and has the following relationship:

(opening width W41 of concaved portion 41)>(nip width Wnp of nip NP)

Accordingly, in the state in which the concaved portion 41 of the secondary transfer roller 42 is opposite to the intermediate transfer member 31, the transfer nip temporarily disappears.

For this reason and the configuration that the secondary transferring backup roller 34 is able to move to or away from the secondary transfer roller 42, the secondary transferring backup roller 34 can be displaced to the secondary transfer roller 42 side in the state in which the concaved portion 41 of the secondary transfer roller 42 is opposite to the intermediate transfer member 31. The stopper member 47 plays a role of restricting the displacement of the secondary transferring backup roller 34.

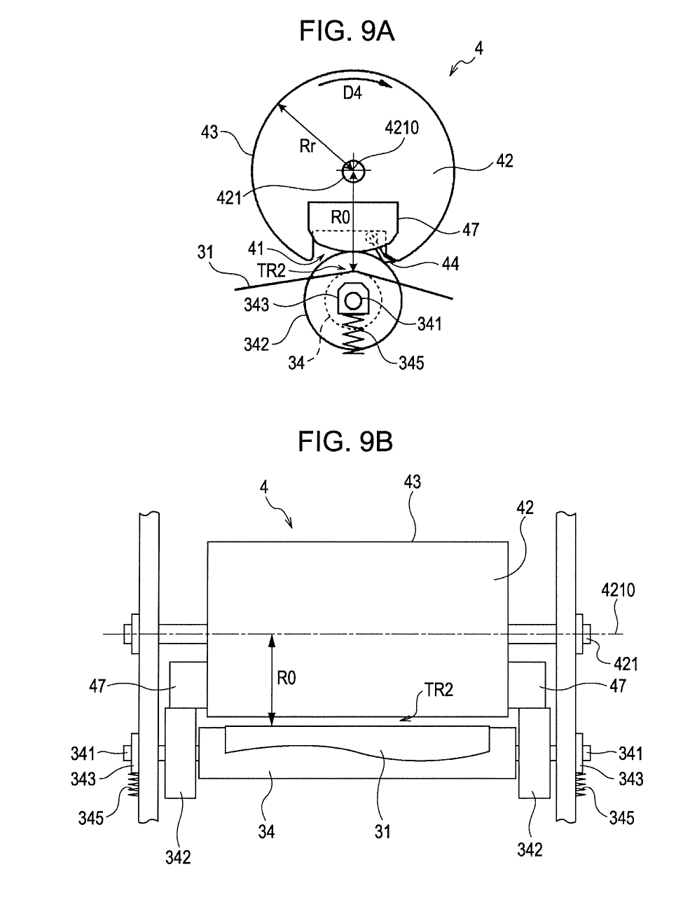

FIG. 9 is a view illustrating the operation of the stopper member according to the embodiment. More specifically, FIG. 9A is a view of the stopper member 47 which is seen from an axial direction when the concaved portion 41 faces the secondary transfer nip position TR2, and FIG. 9B is a view of the stopper member 47 which is seen from a direction perpendicular to the axial direction. As shown in FIG. 9A, the outer circumferential surface of the stopper member 47 is formed in an approximately circular shape with a rotational center 4210 of the secondary transfer roller 42 as the center in the region facing the concaved portion 41 of the secondary transfer roller 42. A bearing 342 is installed at the end portion of the secondary transferring backup roller 34. The bearing 342 has an outer diameter larger than the diameter of the secondary transferring backup roller 34, and is provided coaxially with the secondary transferring backup roller 34 and can be rotated separately from the secondary transferring backup roller 34. When the stopper member 47 of the secondary transferring backup roller 34 faces the secondary transfer roller 42 side, the outer circumferential surface of the stopper member 47 contacts with the outer circumferential surface of the bearing 342 to define the interval between the rotational center 4210 of the secondary transfer roller 42 and the surface of the intermediate transfer member 31 against the pressing force of the pressing member 345.

When the concaved portion 41 is provided at the secondary transfer position TR2 and the stopper member 47 contacts with the bearing 342, the interval R0 from the rotational center 4210 of the secondary transfer roller 42 to the intermediate transfer member 31 is set to be slightly shorter than the radius Rr of the secondary transfer roller 42 on which the elastic layer 43 is formed. In a narrow sense, the interval R0 is set to be equal to the interval between the rotational center 4210 of the secondary transfer roller 42 and the intermediate transfer member 31 in the state in which the secondary transfer nip portion NP2 is formed at the secondary transfer position TR2. When the secondary transfer nip portion NP2 is formed, since the elastic layer 43 is elastically transformed by the pressing force of the pressing member 345, the interval between the rotational center 4210 of the secondary transfer roller 42 and the intermediate transfer member 31 is slightly shorter than the radius Rr of the secondary transfer roller 42 in the state in which the pressing force is not applied. In this state, that is, in the state in which the secondary transfer nip portion NP2 is formed, the interval between the rotational center 4210 of the secondary transfer roller 42 and the intermediate transfer member 31 is R0. Accordingly, the interval between the rotational center 4210 of the secondary transfer roller 42 and the intermediate transfer member 31 is maintained at the almost constant value R0, irrespective of the rotational phase of the secondary transfer roller 42 in this embodiment.

A secondary transfer roller driving motor M5 is mechanically connected to the rotation shaft 421 of the secondary transfer roller 42. In addition, a driver 12 is installed to drive the secondary transfer roller driving motor M5 in this embodiment. The driver 12 drives the motor M4 in accordance with the command output from the controller 10 to rotate the secondary transfer roller 42 in a clockwise direction D4 in the paper plane in FIG. 6, that is, the a with-direction with respect to the belt moving direction D31. The secondary transferring backup roller 34 is a follower roller having no driving source. Since the secondary transferring backup roller 34 opposite to the secondary transfer roller 42 driven by the motor functions as the follower roller, it is possible to prevent slippage between the secondary transfer roller 42 and the intermediate transfer member 31 at the secondary transfer nip portion NP2, or between the intermediate transfer member 31 and the secondary transferring backup roller 34.

In this embodiment, the secondary transfer roller driving motor M5 is installed, as shown in FIG. 7, and is mechanically connected to the secondary transfer roller 42. If the command is input to the driver 15 from the controller 10, the secondary transfer roller driving motor M5 is controlled by the corresponding driver 15 to rotate the secondary transfer roller 42 or stop positioning of the concaved portion 41 in a position facing the secondary transferring backup roller 34 which will be described later.

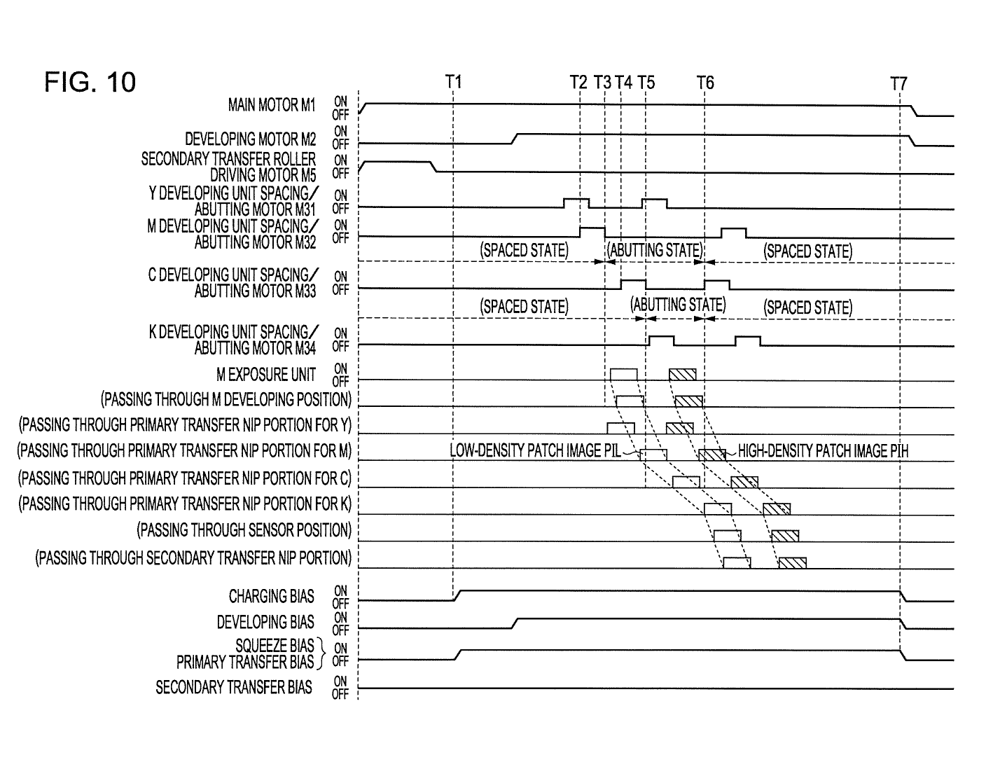

In the image forming apparatus 1 according to the second embodiment, forming of the image under appropriate image forming conditions is required, similar to the image forming apparatus disclosed in JP-A-2009-15351 or the first embodiment. Accordingly, similar to the first embodiment, the low-density patch process and the solid patch process are performed. Since the embodiment employs the secondary transfer roller 42 having the configuration described above, the secondary transfer roller 42 is positioned at the predetermined position before the formation of the low-density patch image PIL and the solid patch image PIH, and then the circumferential surface of the secondary transfer roller 42 is separated from the intermediate transfer member 31. In the separated state, the formation of the patch images PIL and PIH and the density detection are performed. The formation of the low-density patch image and the solid patch image for the magenta color which is the second color, and the operation of density detection for both patch images will now be described in detail with reference to FIG. 10.

FIG. 10 is a timing chart illustrating the formation of the magenta patch image and the operation of density detection in the image forming apparatus in FIG. 6. In the image forming apparatus 1 according to the embodiment, the controller 10 controls the respective units of the apparatus according to the program stored in a memory (not illustrated) of the controller 10 to perform the formation of the low-density patch image and the solid patch image for the magenta color (second color), and the operation of density detection as described follows. That is, similar to the first embodiment, when the main motor M1 starts to operate, the photosensitive drum 21, the intermediate transfer member 31, and the squeeze rollers 251 and 261 are rotated, and simultaneously the controller 10 sends a control command to the driver 15 to control the secondary transfer roller driving motor M5 and thus rotate the secondary transfer roller 42. As shown in FIG. 9, if the outer circumferential surface of the secondary transfer roller 42 is separated from the intermediate transfer member 31 in the state in which the concaved portion 41 of the secondary transfer roller 42 faces the secondary transferring backup roller 34, the rotation of the secondary transfer roller 42 is stopped and is stationary at the position.

In the case of performing the formation of the low-density patch image PIL and the solid patch image PIH and the density detection of each patch image while the secondary transfer roller is positioned, since the reverse bias is not applied to the secondary transfer roller 42 while performing the formation and density detection, it is possible to reliably prevent the secondary transfer roller 42 from being contaminated by the developer. Therefore, in the second embodiment, the reverse bias is not applied, and the formation of each patch image PIL and PIH or the density detection is performed. That is, at the timing T1 after the positioning of the secondary transfer roller 42 is completed, application of charging bias to the charging unit 22, application of squeeze bias to the squeeze rollers 251 and 261, and application of primary transfer bias to the intermediate transfer member 31 are performed. After that, similar to the first embodiment, the formation of the low-density patch image PIL and the solid patch image PIH for the second color and the density detection of each patch image are performed. That is, after the predetermined time has passed from the timing T1, the developing motor M2 starts to rotate, so that the developing roller 241 and the anilox roller are rotated and the application of the developing bias starts. From the subsequent timing T2, the magenta (second color) developing unit separating/contacting motor M32 is operated for a predetermined time, so that the magenta developing unit 24 is moved toward the photosensitive drum 21 by the developing unit separating/contacting mechanism 2402 to contact the developing roller 241 against the surface of the photosensitive drum 21 (contacting state).

In the image forming station 2M, the low-density patch image PIL and the solid patch image PIH are formed in this order, and then are primarily transferred onto the intermediate transfer member 31 at the primary transfer nip portion NP1m. After that, the patch images are transported to the optical sensor PS side through the primary transfer nip portions NP1c and NP1k at the downstream side. However, the developing roller 241 of the developing unit 24 is separated from and is contacted with the photosensitive drum 21 depending upon the kind of the patch images passing through the primary transfer nip portions NP1c and NP1k. That is, before the low-density patch image PIL comes to the primary transfer nip portion NP1c, the cyan (third color) developing unit separating/contacting motor M33 is operated only for a predetermined time (=T5−T4), and the developing unit separating/contacting mechanism 2403 moves the cyan developing unit 24 toward the photosensitive drum 21, so that the developing roller 241 contacts with the surface of the photosensitive drum 21. The contacting state continues until the low-density patch image PIL primarily transferred at the primary transfer nip portion NP1m passes through the primary third color transfer nip portion NP1c.

After that, following the low-density patch image PIL, at the timing T6 before the solid patch image PIH primarily transferred at the primary transfer nip portion NP1m reaches the primary transfer nip portion NP1c, the developing unit separating/contacting motor M33 operates so that the cyan developing unit 24 is separated from the photosensitive drum 21 by the developing unit separating/contacting mechanism 2403. In the state in which the developing unit 24 is separated from the photosensitive drum 21, the solid patch image PIH is transported in the moving direction D31 to follow the low-density patch image PIL, and then passes through the primary third color transfer nip portion NP1c. In the image forming station 2C, the developing unit 24 is separated from and is contacted with the photosensitive drum 21 in accordance with the timing in which the low-density patch image PIL and the solid patch image PIH pass through the primary transfer nip portion NP1c. However, the spacing and contacting operation of the developing unit 24 with respect to the photosensitive drum 21 is similar to that in the fourth color image forming station 2K.

Accordingly, when the low-density patch image PIL transferred in the primary transfer nip portion NP1m passes through the primary transfer nip portions NP1c and NP1k installed at the downstream side of the primary transfer nip portion NP1m in the moving direction D31, the surface of the intermediate transfer member 31 becomes uniform. Accordingly, after the unevenness of the surface is removed, the signal output from the optical sensor PS during passing through the detection range of the optical sensor PS is input to the controller 10 to accurately obtain the image density of the low-density magenta patch image PIL. On the other hand, while the solid patch image PIH transferred at the primary transfer nip portion NP1m passes sequentially through the primary transfer nip portions NP1c and NP1k, the surface layer portion of the liquid carrier is peeled off at the respective primary transfer nip portions NP1c and NP1k. As a result, immediately after passing through the primary transfer nip portion NP1k which is provided at the farthest downstream side in the moving direction D31, the toner forming the solid patch image PIH is exposed to the surface of the solid image PIH. While the solid patch image PIH passes through the detection range of the optical sensor PS, the signal output from the optical sensor PS is transmitted to the controller 10 to accurately obtain the image density of the yellow solid patch image PIH.

As described above, according to the second embodiment, the following working effects are further obtained, as well as the same working effects as those of the first embodiment being obtained. That is, in the state in which the outer circumferential surface of the secondary transfer roller 42 is separated from the intermediate transfer member 31 by positioning the second transfer roller 42 so that the concaved portion 41 of the secondary transfer roller 42 faces the intermediate transfer member 31, since the intermediate transfer member 31, onto which the low-density patch image PIL and the solid patch image PIH are transferred, is rotationally moved, it is possible to reliably prevent the low-density patch image PIL and the solid patch image PIH which are transferred onto the intermediate transfer member 31 from being contaminated due to adherence to the secondary transfer roller 42 during the rotational movement.

In addition, in the second embodiment, the secondary transfer nip portion NP2 corresponds to the “fifth transfer nip portion” of the invention.

In this case, the invention is not limited to the above-mentioned embodiments, and various modifications may be made within the purpose of the invention. For example, although the image forming stations 2Y, 2M, 2C and 2K are arranged in series in the above-mentioned embodiment, the arranging relationship is not limited thereto. In addition, four image forming stations are arranged in series along the winding direction of the belt-type intermediate transfer member 31, but the number or arrangement of the image forming stations is not limited thereto.

In addition, although the belt-type intermediate transfer member 31 is used as the “transfer medium” of the invention in the above-mentioned embodiments, for example, a drum-type intermediate transfer member may be used.

The entire disclosure of Japanese Patent Application No: 2009-251907, filed Nov. 2, 2009 is expressly incorporated by reference herein.

What is claimed is:

1. An image forming apparatus comprising:
a first latent image carrier that carries a first latent image;
a first developing member that contacts with the first latent image carrier and that develops the first latent image carried on the first latent image carrier by a first liquid developer including a liquid carrier and toner;
a second latent image carrier that carries a second latent image;
a second developing member that contacts with the second latent image carrier and that develops the second latent image carried on the second latent image carrier by a second liquid developer which is different from the first liquid developer;
a transfer medium that contacts with the first latent image carrier, that forms a first transfer nip portion, onto which the first image developed on the first latent image carrier is transferred at the first transfer nip portion, that contacts with the second latent image carrier, and that forms a second transfer nip portion, onto which the second image developed on the second latent image carrier is transferred at the second transfer nip portion;
a detecting unit that detects the image transferred onto the transfer medium; and
a control unit, that, when a first image developed on the first latent image carrier is an image of a first image density, causes the detecting unit to detect the first image passed through the second transfer nip portion which is formed by the transfer medium and the second latent image carrier while the second developing member contacts with the second latent image carrier, and that, when the first image is an image of a second image density which is higher than the first image density, causes the second developing member to be separated from the second latent image carrier, and causes the detecting unit to detect the first image passed through the second transfer nip portion which is formed by the transfer medium and the second latent image carrier while the second developing member separates from the second latent image carrier.

2. The image forming apparatus according to claim 1, further comprising:
a third latent image carrier that contacts with the transfer medium, that forms a third transfer nip portion, and that carries a third latent image; and
a third developing member that contacts with the third latent image carrier and develops the latent image carried on the third latent image carrier by a third liquid developer which is different from the first liquid developer and the second liquid developer;
wherein when the first image is the image of the first image density, the control unit causes the detecting unit to detect the first image passed through the third transfer nip portion which is formed by the transfer medium and the third latent image carrier while the third developing member contacts with the second latent image carrier and that, when the first image is the image of the second image density which is higher than the first image density, the control unit causes the third developing member to be separated from the third latent image carrier, and causes the detecting unit to detect the first image passed through the third transfer nip portion which is formed by the transfer medium and the third latent image carrier while the third developing member separates from the third latent image carrier.

3. An image forming apparatus comprising:
a first latent image carrier that carries a first latent image;
a first developing member that contacts with the first latent image carrier and that develops the first latent image by a first liquid developer including a liquid carrier and toner;
a second latent image carrier that carries a second latent image;
a second developing member that contacts with the second latent image carrier and that develops the second latent image by a second liquid developer which is different from the first liquid developer;
a third latent image carrier that carries a third latent image; and
a third developing member that contacts with the third latent image carrier and that develops the third latent image by a third liquid developer which is different from the first liquid developer and the second liquid developer;
a transfer medium that contacts with the first latent image carrier, forms a first transfer nip portion, onto which the first image is transferred at the first transfer nip portion, contacts with the second latent image carrier, forms a second transfer nip portion, onto which the second image is transferred at the second transfer nip portion, contacts with the third latent image carrier and forms a third transfer nip portion, onto which the third image is transferred at the third transfer nip portion;
a detecting unit that detects the image transferred onto the transfer medium; and
a control unit, that, when a second image developed on the second latent image carrier is an image of a first image density, causes the detecting unit to detect the second image passed through the third transfer nip portion which is formed by the transfer medium and the third latent image carrier while the third developing member contacts with the third latent image carrier, and that, when the second image is an image of a second image density which is higher than the first image density, causes the third developing member to be separated from the third latent image carrier, and causes the detecting unit to detect the second image passed through the third transfer nip portion which is formed by the transfer medium and the third latent image carrier while the third developing member separates from the third latent image carrier.

4. The image forming apparatus according to claim 3, further comprising:
a fourth latent image carrier that contacts with the transfer medium, forms a fourth transfer nip portion and carries a fourth latent image; and
a fourth developing member that contacts with the fourth latent image carrier and develops the fourth latent image by a fourth liquid developer which is different from the first liquid developer, the second liquid developer and the third liquid developer;
wherein when the second image is the image of the first image density, the control unit causes the detecting unit to detect the second image passed through the fourth transfer nip portion which is formed by the transfer medium and the fourth latent image carrier while the fourth developing member contacts with the fourth latent image carrier, and when the second image is the image of the second image density which is higher than the first image density, the control unit causes the fourth developing member to be separated from the fourth latent image carrier, and causes the detecting unit to detect the second image passed through the fourth transfer nip portion which is formed by the transfer medium and the fourth latent image carrier while the fourth developing member separates from the fourth latent image carrier.

5. The image forming apparatus according to claim 1, further comprising:
a transfer roller with a concaved portion formed in a circumferential surface, in which when the concaved portion is not opposite to the transfer medium, the transfer roller contacts with the transfer medium and forms a nip portion, with a recording medium being interposed between the transfer roller and the transfer medium, and the image transferred on the transfer medium is transferred to the recording medium at the nip portion,
when the detecting unit detects the image, the control unit controls so that the concaved portion is opposite to the transfer medium to stop rotation of the transfer roller.

6. The image forming apparatus according to claim 1, wherein the transfer medium has an elastic layer.

7. An image forming method comprising the steps of:
transferring an image of a first image density, which is developed on a first latent image carrier by a first developing member using a liquid developer containing a liquid carrier and toner, onto a transfer medium;
passing the image of the first toner density, which is transferred onto the transfer medium, through a second transfer nip portion formed by the transfer member and a second latent image carrier while a second developing member contacts with the second latent image carrier;
detecting the image of the first image density passed through the second transfer nip portion at a detecting unit;
transferring an image of a second image density, which is higher than the first image density, onto the transfer medium;
separating the second developing member from the second latent image carrier, and passing the image of the second image density through the second transfer nip portion formed by the transfer member and the second latent image carrier while the second developing member separates the second latent image carrier; and
detecting the image of the second image density having passed through the second transfer nip portion at the detecting unit.
